(19) United States
(12) Patent Application Publication
(10) Pub. No.: US 2013/0041533 A1
(43) Pub. Date: Feb. 14, 2013

(54) SHIFTING SYSTEM CONTROL FOR A HYBRID VEHICLE

(71) Applicant: Sang Joon Kim, Seoul (KR)

(72) Inventor: Sang Joon Kim, Seoul (KR)

(73) Assignees: KIA MOTORS CORPORATION, Seoul (KR); HYUNDAI MOTOR COMPANY, Seoul (KR)

(21) Appl. No.: 13/307,725

(22) Filed: Nov. 30, 2011

(30) Foreign Application Priority Data
Aug. 11, 2011 (KR) 10-2011-0080319

(51) Int. Cl. B60W 20/00

(52) U.S. Cl. 701/22; 180/65.275; 903/915; 180/65.265; 903/930

(57) ABSTRACT

The present invention relates to a control of a shifting system for a hybrid vehicle which may improve drivability when shift mode is changed to neutral mode. Shifting system control may comprise determining when a current shift gear is in a neutral shift, controlling torque of an engine corresponding to friction torque and torque of a second motor/generator to “0” if the current shift gear is in the neutral shift and controlling operating hydraulic pressure to “0” if the engine torque corresponds to the friction torque and the torque of the second motor/generator is “0”.

### CROSS-REFERENCE TO RELATED APPLICATION

This application claims priority to and the benefit of Korean Patent Application No. 10-2011-0080319 filed in the Korean Intellectual Property Office on Aug. 11, 2011, the entire contents of which are incorporated herein by reference.

### BACKGROUND OF THE INVENTION

(a) Field of the Invention

The present invention relates to control of a shifting system for a hybrid vehicle. More particularly, the present invention relates to control of a shifting system for a hybrid vehicle which may improve drivability when a shift mode is changed to a neutral mode.

(b) Description of the Related Art

Recently, hybrid vehicles and electric vehicles have received attention as environmentally-friendly vehicles due to energy and environmental pollution problems. The environmentally-friendly vehicles generally include a motor driven by a battery.

Meanwhile the hybrid vehicle includes an engine and a motor as a driving source. The hybrid vehicle includes a starting motor and at least one of planetary gear sets and a plurality of friction elements for connecting the electric drive motor and a combustion engine. And thus, a plurality of shift modes may be realized according to connection of the planetary gear sets and friction elements. In this case, the starting motor means a motor which rotates a crankshaft for an engine to start and a drive motor denotes a motor which drives a vehicle.

A transmission applied to a hybrid vehicle is generally a continuously variable transmission or an automatic transmission. In the continuously variable transmission or the automatic transmission, neutral shift means a state of which torque of a driving source is not transmitted to a drive shaft, that is the driving source is separated from the drive shaft, for example “P” (park) shift or “N” (neutral) shift. That is, the driving source and the drive shaft are physically separated from each other by releasing friction elements such as a brake or a clutch.

However, shift shock may occur due to torque of an engine and a motor or hydraulic pressure supplied to friction elements when the shift mode is changed to the neutral mode.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for controlling a shifting system for a hybrid vehicle which may minimize shift shock when the shift mode is changed to a neutral mode.

Also, the shifting system control for a hybrid vehicle may improve drivability and increase customer satisfaction.

A method of controlling a shifting system may be used for a hybrid vehicle comprising a transmission including at least one of planetary gear set and a plurality of friction elements, a driving source including an engine and a first and second motor/generator, a battery supplying power to the first and second motor/generator and at least at least one of control unit controlling operations of the transmission and the driving source. The control method according to the exemplary embodiment of the present invention may include determining current shift gear is in neutral shift, controlling torque of the engine corresponding to friction torque and torque of the second motor/generator to “0” if the current shift gear is in neutral shift and controlling operating hydraulic pressure to “0” if the engine torque corresponds to the friction torque and the torque of the second motor/generator is “0”.

The control method may further include determining the transmission is in a neutral shift and the engine speed is stabilized and controlling torque of the second motor/generator to charging torque if the transmission is in neutral shift and the engine speed is stabilized.

The first motor/generator may be a starting motor.

Controlling the torque of the engine corresponding to friction torque and torque of the second motor/generator to “0” may be executed by LPF (low pass filter) controlling.

The battery may be charged by idle torque of the engine if the second motor/generator is controlled to charging torque.

The at least one control unit may include a central control unit generally controlling other controlling units, an engine control unit receiving engine torque target value from the central control unit and controlling operation of the engine, a motor control unit receiving motor torque target value from the central control unit and controlling operations of the first and second motor/generator, and a transmission control unit receiving a required shift mode from the central control unit, shifting the shift mode of the transmission, and transmitting current shift mode to the central control unit.

According to the exemplary embodiment of the present invention, impact, which may be generated by torque of an engine and a second motor/generator, or hydraulic pressure supplied to friction elements, may be reduced. And thus, shift shock may be minimized when the shift mode is changed to a neutral mode.

Drivability and customer's satisfaction may also thus be improved due to minimization of shift shock.

### BRIEF DESCRIPTION OF THE DRAWINGS

FIG. 1 is a schematic diagram of a shifting system for a hybrid vehicle according to an exemplary embodiment of the present invention.

FIG. 2 is a control diagram of constituent elements according to an exemplary embodiment of the present invention in each control stages.

FIG. 3 is a block diagram showing a relationship between control units and constituent elements according to an exemplary embodiment of the present invention.

FIG. 4 is a flowchart showing a method of controlling a shifting system for a hybrid vehicle according to an exemplary embodiment of the present invention.

### DESCRIPTION OF SYMBOLS

10: engine;

20: the first motor/generator;

30: second motor/generator;

40: battery;

50: transmission case;

55: transmission;

60: central control unit;

70: engine control unit;

80: motor control unit;

90: transmission control unit;

PG1: first planetary gear set;

S1: the first sun gear;

PC1: first planetary carrier;

R1: first ring gear;

PG2: second planetary gear set;

S2: second sun gear;

PC2: second planetary carrier;

R2: second ring gear;

CL1: first clutch;

CL2: second clutch;

BK1: first brake;

BK2: second brake;

IS1: first input shaft;

IS2: second input shaft;

IS3: third input shaft; and

OS: output shaft.

### DETAILED DESCRIPTION OF THE EMBODIMENTS

An exemplary embodiment of the present invention will hereinafter be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

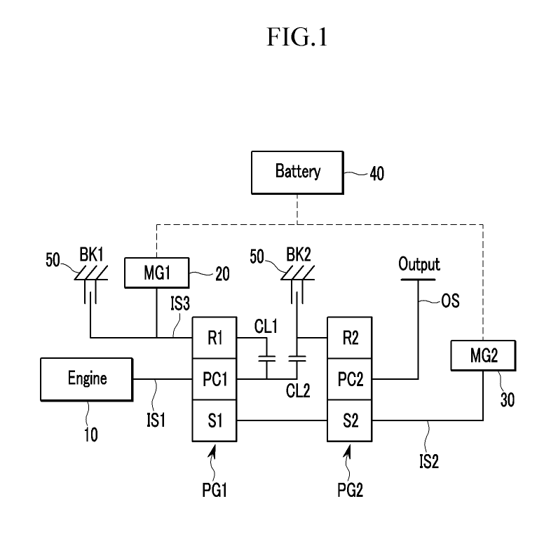

FIG. 1 is a schematic diagram of a shifting system for a hybrid vehicle according to an exemplary embodiment of the present invention.

As shown in FIG. 1, a powertrain of a hybrid vehicle according to an exemplary embodiment of the present invention includes an engine 10, a first motor/generator 20, a second motor/generator 30, a first, second, and third input shaft IS1, IS2, and IS3, an output shaft OS, a first and second planetary gear set PG1 and PG2.

The engine 10 supplies power to the first input shaft IS1.

The first motor/generator 20 supplies power to the third input shaft IS3. The first motor/generator 20 may be a starting motor to supplies power to the engine 10 for the engine 10 to start.

The second motor/generator 30 supplies power to the second input shaft IS2.

The first motor/generator 20 and the second motor/generator 30 receive electric power from a battery 40 and outputs power.

The first input shaft IS1 transmits the supplied power from the engine 10 to the first planetary gear set PG1.

The second input shaft IS2 transmits the supplied power from the second motor/generator 30 to the second planetary gear set PG2.

The third input shaft IS3 transmits the supplied power from the first motor/generator 20 to the first planetary gear set PG1.

The output shaft OS outputs power from the powertrain.

The first planetary gear set PG1 includes a first sun gear S1, a first planetary carrier PC1 and a first ring gear R1 as operating members and is a single pinion planetary gear set. The first planetary carrier PC1 rotates with a pinion gear (not shown) engaged with the first sun gear S1 and the first ring gear R1.

The second planetary gear set PG2 includes a second sun gear S2, a second planetary carrier PC2 and a second ring gear R2 as operating members and is a single pinion planetary gear set. The second planetary carrier PC2 rotates with a pinion gear (not shown) engaged with the second sun gear S2 and the second ring gear R2.

The first planetary gear set PG1 and the second planetary gear set PG2 are disposed on the same shaft axis.

The first sun gear S1 and the second sun gear S2 are fixedly connected to the second motor/generator 30.

The first planetary carrier PC1 is fixedly connected to the engine 10 and is selectively connected to the first ring gear R1 and the second ring gear R2 respectively. In this case, the selective connection of the first planetary carrier PC1 and the first ring gear R1 means a connection for two operating members to rotate integrally different from the connection of the pinion gear.

The first ring gear R1 is fixedly connected to the first motor/generator 20 and selectively connected to a transmission case 50.

The second ring gear R2 is selectively connected to the transmission case 50.

The second planetary carrier PC2 is fixedly connected to the output shaft OS.

The powertrain for a hybrid vehicle according to the exemplary embodiment of the present invention includes a plurality of friction elements CL1, CL2, BK1 and BK2 which mutually connects the operating members of the first and second planetary gear set PG1 and PG2 to each other or to the transmission case 50.

The first clutch CL1 selectively connects the first planetary carrier PC1 with the first ring gear R1, and the second clutch CL2 selectively connects the first planetary carrier PC1 with the second ring gear R2.

The first brake BK1 selectively connects the first ring gear R1 to the transmission case 50 and the second brake BK2 selectively connects the second ring gear R2 to the transmission case 50.

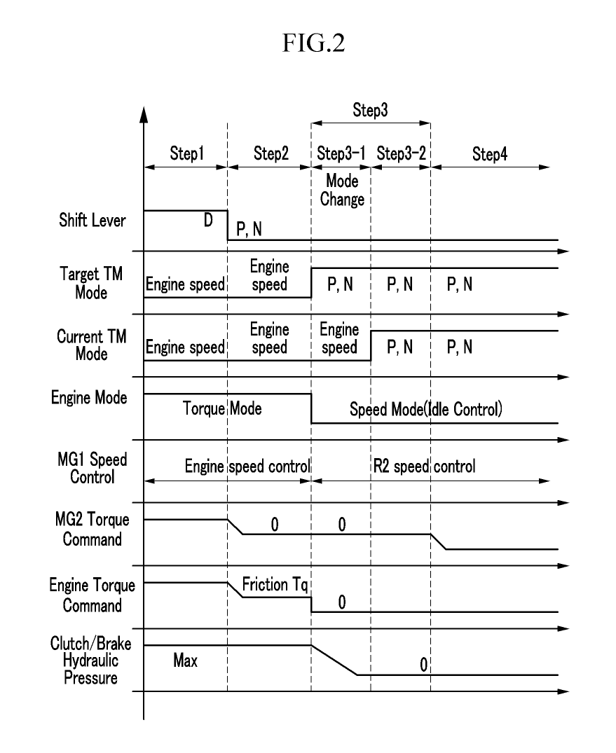

FIG. 2 is a control diagram constituent elements according to an exemplary embodiment of the present invention in each control stages.

As shown in FIG. 2, a control method of a shifting system according to an exemplary embodiment of the present invention will be described referring to operations of each constituent element in Step1 to Step4.

The shifting system includes the engine 10, transmission 55 as constructed in FIG. 1, the first and second motor/generator 20 and 30 and the friction elements CL1, CL2, BK1 and BK2. In the FIG. 2, the transmission 55 is denoted as TM.

When rotation speed of the driving source 10, 20, and 30 is supplied to the transmission 55 via the input shafts IS1, IS2 and IS3, the transmission 55 outputs through the output shaft OS according to connection or disconnection of the friction elements CL1, CL2, BK1 and BK2.

A target TM mode means an operation state of the transmission 55 which is required for gaining target output value, and current TM mode means current operation state of the transmission 55.

Hereinafter, operation states of the constituent elements in Step1 will be described.

Step1 denotes that shift mode is driving mode (D).

When shift mode is driving mode (D), the driving source and the drive shaft are physically connected and thus torque of the driving source is transmitted to the drive shaft. The driving source includes the engine 10 and the first and second motor/generator 20 and 30.

In the target TM mode of the transmission 55, it is required connection or disconnection of the friction elements for rotation speed of the engine 10 to be changed to target output value. In the current TM mode of the transmission 55, rotation speed of the engine 10 is changed according to current connection or disconnection of the friction elements. That is, the target TM mode and the current TM mode of the transmission 55 mean operation state of transmission 55 which receives rotation speed of the engine 10 and outputs changed rotation speed.

The engine 10 outputs predetermined torque value and the engine 10 is connected with the drive shaft for supplying torque to the drive shaft, that is, operates as torque mode. The predetermined torque value of the engine 10 may be sufficient to accelerate a vehicle.

The first motor/generator 20 controls engine speed by selective connection of the friction elements CL1, CL2, BK1 and BK2.

The second motor/generator 30 outputs predetermined torque value.

In this case, operating hydraulic pressure for operated friction elements of the friction elements CL1, CL2, BK1 and BK2 is maximized.

Hereinafter, operation states of the constituent elements in Step2 will be described.

Step2 denotes that shift mode is parking mode (P) or neutral mode (N). In this case, while the neutral gear shift is expressed as P or N, however a shift lever may be changed to N only, not P in driving state.

If a shift lever is changed to N shift in driving condition, the driving source is separated from the drive shaft and thus torque of the driving source is not transmitted to the drive shaft. In the early stage of Step2, operating hydraulic pressure of the friction elements CL1, CL2, BK1 and BK2 is not instantly changed to “0” for minimizing shift shock but slowly reduced passing through stage of which torque of the driving source is controlled.

Because the operating hydraulic pressure of the friction elements CL1, CL2, BK1 and BK2 is not immediately released, except for the engine 10 and the second motor/generator 30 of which torque value is controlled, other constituent elements maintain their operation state as Step1. And thus, description of other constituent elements maintaining their operation state as described in the Step1 will be omitted.

Torque value of the engine 10 is controlled corresponding to friction torque applied to the engine 10. And thus, a vehicle may drive at constant velocity.

Torque value of the second motor/generator 30 is controlled to “0”.

Hereinafter, operation states of the constituent elements in Step3-1 and Step3-2 of Step3 sequentially will be described.

In Step3-1, operating hydraulic pressure of the friction elements CL1, CL2, BK1 and BK2 is released after shift mode is changed to the P or N. As described above, a shift lever is changed to the N only in driving condition.

After the shift mode is changed to the N and the torque of the driving source is controlled, controlling of the operating hydraulic pressure of the friction elements CL1, CL2, BK1 and BK2 is executed.

The target TM mode of the transmission 55 maintains operation state of the transmission 55 relationless with rotation speed of the engine 10. That is, in the target TM mode of the transmission 55, the transmission 55 operates with complete releasing of the operating hydraulic pressure of the friction elements CL1, CL2, BK1 and BK2. However, the operating hydraulic pressure of the friction elements CL1, CL2, BK1 and BK2 is released gradually, and thus the current TM mode of the transmission 55 is maintained until complete releasing of the operating hydraulic pressure. Thus, the transmission 55 changes rotation speed of the engine 10 and outputs according to current connection or disconnection of the friction elements.

The torque of the engine 10 is controlled to “0”. The engine 10 is controlled as idle condition, and thus it does not influence to vehicle' speed change. In FIG. 2, that engine 10 operation condition is noted as speed mode.

If the engine is controlled to idle and the operating hydraulic pressure of the friction elements CL1, CL2, BK1 and BK2 is released, the first motor/generator 20 controls speed of the second ring gear R2. If shift mode, previously in the neutral shift mode, realized relatively low output speed because the second ring gear R2 was restrained by the second brake BK2, the first motor/generator 20 controls speed of the second ring gear R2 to “0”. If shift mode, previously in the neutral shift mode, realized relatively high output speed because the second ring gear R2 was not restrained by the second brake BK2, the first motor/generator 20 controls speed of the second ring gear R2 corresponding to rotation speed of the engine 10. The first ring gear R1 rotates with the first motor/generator 20 integrally, the first planetary carrier PC1 rotates with the engine 10 integrally, and thus rotation speed of the first sun gear S1 may be determined. And the second sun gear S2 rotates with the first sun gear S1 integrally and thus rotation speed of the second ring gear R2 may be determined. That is, speed control of the second ring gear R2 is executed, and the rotation speed of the second ring gear R2 may be controlled as determined speed by controlling of torque value control of the first motor/generator 20.

Torque value of the second motor/generator 30 may be controlled to be maintained as “0”.

In this case, operating hydraulic pressure of the friction elements CL1, CL2, BK1 and BK2 is gradually changed to “0”.

Step3-2 denotes complete releasing of the operating hydraulic pressure of the friction elements CL1, CL2, BK1 and BK2 after shift mode is changed to P or N. In Step3-2, the operating hydraulic pressure is “0” because the operating hydraulic pressure of the friction elements CL1, CL2, BK1 and BK2 is controlled from Step3-1.

The target TM mode of the transmission 55 maintains operation state of the transmission 55 regardless of the rotation speed of the engine 10 as in Step3-1. Also, the current TM mode of the transmission 55 is not influenced by rotation speed of the engine 10 because the operating hydraulic pressure of the friction elements CL1, CL2, BK1 and BK2 is completely released. And thus, the target TM mode and the current TM mode are identical.

The engine 10 is controlled to disconnect with the drive shaft and be maintained to output “0” torque. The engine 10 is controlled to be idle state for not influencing vehicle's speed change, in other words, speed mode is executed.

The first motor/generator 20 controls speed of the second ring gear R2 as Step3-1. Repeated description of the second ring gear R2 identical to Step3-1 will be omitted. The speed control of the second ring gear R2 from Step3 may facilitate hydraulic pressure control of the friction elements CL1, CL2, BK1 and BK2 by mating rotation speed of the operation elements when shift mode is changed from neutral shift mode to another shift mode.

The torque value of the second motor/generator 30 is controlled to maintain “0”.

In this case, the operating hydraulic pressure of the friction elements CL1, CL2, BK1 and BK2 is “0”.

Hereinafter, operation states of the constituent elements in Step4 will be described.

In Step4, except for operation of the second motor/generator MG2, operations of other constituent elements are identical to Step3-2, repeated description will be omitted.

In Step4, the second motor/generator MG2 is controlled to maintain a torque value at which the battery 40 is charged by the engine 10. After the shift mode is completely changed to the neutral shift mode through the Step 1 to Step 3 and rotation speed of the engine 10 is stabilized, the second motor/generator MG2 is driven as charging torque, thus being operated as a generator by idle torque of the engine 10 and thus the battery 40 is charged.

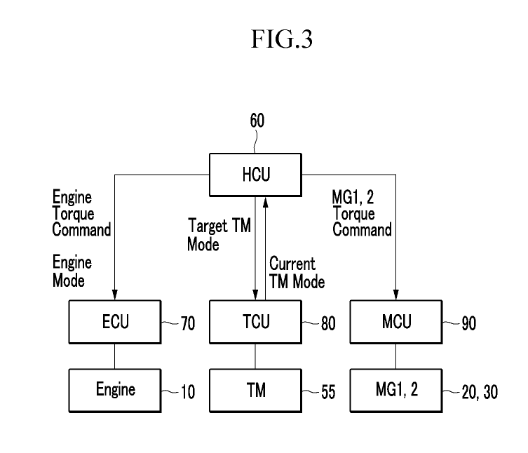

Hereinafter, referring to FIG. 3, control units of the constituent elements will be described.

FIG. 3 is a block diagram showing relationship between control units and constituent elements according to an exemplary embodiment of the present invention.

The shifting system of a hybrid vehicle according to an exemplary embodiment of the present invention includes a plurality of control units. The plurality of control units control each constituent element described in FIG. 2.

The plurality of control units may include a central control unit 60, an engine control unit 70, a motor control unit 80 and a transmission control unit 90.

The central control unit 60 may be a hybrid control unit (HCU) of a hybrid vehicle and controls the engine control unit 70, the motor control unit 80 and the transmission control unit 90. Also, the central control unit 60 receives operation conditions of the engine 10, the first and second motor/generator 20 and 30 and transmission 55 from the engine control unit 70, the motor control unit 80 and the transmission control unit 90.

The engine control unit 70 receives control signal from the central control unit 60 and controls operation of the engine 10. That is, the engine control unit 70 receives required torque and mode command signal from the central control unit 60 situationally and controls operation of the engine 10.

The motor control unit 80 receives control signal from the central control unit 60 and controls operation of the motor. That is, the motor control unit 80 receives required torque command signal from the central control unit 60 situationally and controls operations of the first and second motor/generator 20 and 30.

The transmission control unit 90 receives control signal from the central control unit 60 and controls operation of the transmission 55. That is, the transmission control unit 90 receives required mode command signal from the central control unit 60 situationally and controls operation of the transmission 55. Also, the transmission control unit 90 transmits the current TM mode signal of the transmission 55 to the central control unit 60. In this case, the transmission 55 is the powertrain shown in FIG. 1.

The signal transmitting between the pluralities of control units 60, 70, 80 and 90 may be electrical signal.

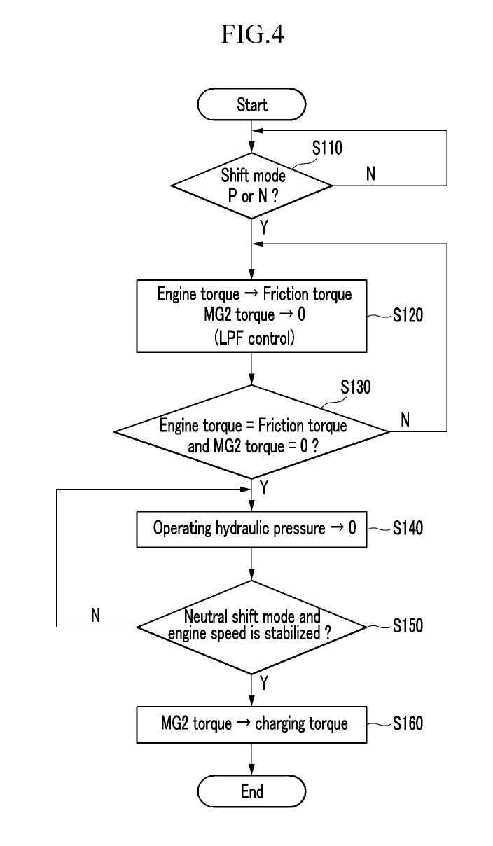

FIG. 4 is a flowchart showing a control method of a shifting system for a hybrid vehicle according to an exemplary embodiment of the present invention.

As shown in FIG. 4, when a vehicle is in driving, the central control unit 60 detects a current shift mode based on signal from each control units 70, 80, and 90 or separate detector (not shown) in step S110. Simultaneously the central control unit 60 determines whether the shift condition to neutral shift mode is satisfied.

If the current shift mode is not P or N, the central control unit 60 repeats detecting the current shift mode in S110.

If the current shift mode is P or N, the engine control unit 70 receives command signal from the central control unit 60 and controls torque of the engine 10 to be corresponded to friction torque in step S120. Also, the motor control unit 90 controls torque of the second motor/generator 30 to be “0” in step S120. The torque is controlled such that torque less than predetermined value is transmitted to the engine 10 and the second motor/generator 30. For controlling the torque, an LPF (Low Pass Filter) control may be used. The LPF control is known generally to a person skilled in the art, and thus detailed description will be omitted.

The central control unit 60 then receives a signal indicating an operation condition of the engine 10 and the second motor/generator 30 from the engine control unit 70 and motor control unit 90, respectively, and determines whether the torque of the engine 10 is identical to the friction torque and the torque of the second motor/generator 30 is “0” in step S130.

If the torque of the engine 10 is not identical to the friction torque, or the torque of the second motor/generator 30 is not “0”, the process returns to the step S120.

If, on the other hand, the torque of the engine 10 is identical to the friction torque and the torque of the second motor/generator 30 is “0”, the operating hydraulic pressure supplied to the friction elements is controlled to be “0” in step S140. That is, each friction element is controlled to be disengaged. The disengagement of the friction elements is executed by gradually shutting off supplying hydraulic pressure gradually for reducing impact in shift changing.

The central control unit 60 next determines whether the shift change to the neutral shift mode of the transmission 55 is completed and speed of the engine 10 is stabilized in step S150. The above determination may be executed based on the central control unit 60 receiving the current TM mode of the transmission 55 from the transmission control unit 90 and speed of the engine 10 idle controlled from the engine control unit 70. That is, when the engine 10 rotates at idle speed and speed change of the engine is within predetermined range, it may then be determined that the engine 10 is stabilized.

If the shift change to the neutral shift mode of the transmission 55 is not completed and speed of the engine 10 is not stabilized, the process returns to the step S140.

If, however, the shift change to the neutral shift mode of the transmission 55 is completed and speed of the engine 10 is stabilized, the motor control unit 90 controls the second motor/generator 30 to be operated as charging torque in step S160. When the second motor/generator 30 is operated as the charging torque, the battery 40 is charged by the idle torque of the engine 10.

As described above, according to the exemplary embodiment of the present invention, the impact due to the torque of the engine and the second motor/generator and the hydraulic pressure of the friction elements may be reduced. And thus, shift shock may be reduced when the shift mode is changed to a neutral shift mode while driving.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method for control of a shifting system of a hybrid vehicle having a transmission including at least one of planetary gear set and a plurality of friction elements, a driving source including an engine and a first and second motor/generator, a battery supplying power to the first and second motor/generator, and at least one control unit to control operations of the transmission and the driving source, the method comprising:
determining whether a current shift gear is in a neutral shift;
in response to the current shift gear being in the neutral shift, controlling torque of the engine corresponding to friction torque and controlling torque of the second motor/generator to “0”; and
controlling operating hydraulic pressure supplied to the friction elements to “0” if the engine torque corresponds to the friction torque and the torque of the second motor/generator is “0”.

2. The method of claim 1, wherein the method further comprises:
determining whether the transmission is in the neutral shift while engine speed is stabilized; and
in response to the transmission being in neutral shift while the engine speed is stabilized, controlling torque of the second motor/generator to charging torque.

3. The method of claim 1, wherein the first motor/generator is a starting motor.

4. The method of claim 1, wherein controlling torque of the engine corresponding to friction torque and torque of the second motor/generator to “0” is executed by LPF (low pass filter) controlling.

5. The method of claim 1, wherein the battery is charged by idle torque of the engine when the second motor/generator is controlled to charging torque.

6. The method of claim 1, wherein the at least one control unit comprises:
a central control unit;
an engine control unit configured to receive engine torque target value from the central control unit and to control operation of the engine;
a motor control unit configured to receive motor torque target value from the central control unit and to control operations of the first and second motor/generator; and
a transmission control unit configured to receive required shift mode from the central control unit, shift the shift mode of the transmission, and transmit the current shift mode to the central control unit.

7. A hybrid vehicle, comprising:
a transmission including at least one of planetary gear set and a plurality of friction elements;
a driving source including an engine and a first and second motor/generator;
a battery to supply power to the first and second motor/generator; and
at least one control unit configured to control operations of the transmission and the driving source, the at least one control unit configured specifically to:
determine whether a current shift gear is in a neutral shift;
in response to the current shift gear being in the neutral shift, control torque of the engine corresponding to friction torque and control torque of the second motor/generator to “0”; and
control operating hydraulic pressure supplied to the friction elements to “0” if the engine torque corresponds to the friction torque and the torque of the second motor/generator is “0”.

8. The vehicle of claim 7, wherein the at least one control unit is further configured to:
determine whether the transmission is in the neutral shift while engine speed is stabilized; and
in response to the transmission being in neutral shift while the engine speed is stabilized, control torque of the second motor/generator to charging torque.

9. The vehicle of claim 7, wherein the first motor/generator is a starting motor.

10. The vehicle of claim 7, further comprising: a low pass filter (LPF), wherein controlling torque of the engine corresponding to friction torque and torque of the second motor/generator to “0” is executed by LPF controlling.

11. The vehicle of claim 7, wherein the battery is charged by idle torque of the engine when the second motor/generator is controlled to charging torque.

12. The vehicle of claim 1, wherein the at least one control unit comprises:
a central control unit;
an engine control unit configured to receive engine torque target value from the central control unit and to control operation of the engine;
a motor control unit configured to receive motor torque target value from the central control unit and to control operations of the first and second motor/generator; and
a transmission control unit configured to receive required shift mode from the central control unit, shift the shift mode of the transmission, and transmit the current shift mode to the central control unit.
